(19) United States
(12) Patent Application Publication
(10) Pub. No.: US 2010/0083940 A1
(43) Pub. Date: Apr. 8, 2010

(54) CRYOGENIC AIR COOLER FOR IMPROVING POWER AND FUEL EFFICIENCY OF A MOTOR VEHICLE INTERNAL COMBUSTION ENGINE

(76) Inventor: Woodford Leon Vrazel, Danbury, TX (US)

Correspondence Address: Russ Weinzimmer, 614 Nashua Street, Suite 53, Milford, NH, 03055, US

(21) Appl. No.: 12/245,721

(22) Filed: Oct. 4, 2008

(51) Int. Cl. F02M 31/20; F28D 15/00

(52) U.S. Cl. 123/542; 165/104.19

(57) ABSTRACT

A cryogenic air condenser is disclosed that pre-cools and thereby condenses air before it enters an internal combustion engine of a vehicle, allowing more fuel to be burned during each combustion cycle and enhancing the power of the engine without placing any drag on the engine. The air is cooled by making thermal contact with a cryogenic liquid, such as liquid nitrogen, liquid air, or liquid helium. For example, the air can flow through pipes surrounded by cryogenic liquid, or air can flow past pipes filled with cryogenic liquid. Cooling of the combustion chamber by the chilled air also allows higher compression ratios without dieseling, and slower burning of the fuel, thereby providing additional enhancements. The cryogenic air condenser requires no modifications to the engine, and can be added to a vehicle after manufacture. Evaporated cryogenic liquid can be vented into the vehicle exhaust, providing Venturi suction for additional cooling.

### FIELD OF THE INVENTION

The invention generally relates to internal combustion engines, and more specifically to methods and apparatus for boosting power and fuel efficiency of an internal combustion engine of a motor vehicle.

### BACKGROUND OF THE INVENTION

Power and fuel efficiency are among the most significant parameters to be considered when evaluating a motor vehicle's performance. Motor vehicle users prefer having high power available for a rapid pick up and a better driving experience. On the other hand, saving precious fuel is also a very important factor.

Various approaches have been used in the art to increase the power and/or efficiency of internal combustion engines. One approach is an alternate “V” placement of engine cylinders, instead of the regular in-line arrangement. This approach delivers the same amount of power in a smaller space and with less engine weight, thereby improving vehicle performance and efficiency. However, no actual increase in power is realized, but only a modest reduction in vehicle weight.

Cylinder volumes can also be increased so as to provide for more fuel combustion per stroke. This technique necessarily enlarges the size and weight of the engine, thereby increasing the weight of the vehicle and reducing the fuel economy. Also, changes to the cylinder arrangement and/or size must be included at the time of manufacture, and cannot be implemented to boost power and performance after the engine has been produced.

Other techniques attempt to balance the requirements of low engine weight and increased power generation by enhancing power without increasing combustion volume, and some of these techniques can be implemented after the engine has been manufactured. In particular, a supercharger compresses ambient air and delivers the compressed air to the intake manifold of the engine. Because the air is at a higher density, a greater amount of air enters the engine cylinder. The additional air increases the power by allowing additional fuel to be combusted within the same cylinder volume. However, a supercharger requires a source of energy to drive its compressor. One type of supercharger, typically referred to as a turbocharger, obtains this energy by placing an air turbine in the exhaust stream. However, this causes backpressure in the exhaust, and therefore reduces the power boost provided by the turbocharger. Other types of supercharger are driven mechanically by belts connected to the engine or electrically by the battery and alternator. In all cases, a supercharger extracts energy from the engine so as to drive a compressor, thereby reducing its power boost and fuel efficiency.

### SUMMARY OF THE INVENTION

A cryogenic air condenser is claimed that pre-cools and thereby condenses air before the air enters an internal combustion engine. This allows more fuel to be burned during each combustion cycle, thereby enhancing the power of the engine without increasing combustion volume. In addition, due to cooling of the combustion chamber by the pre-cooled air, higher compression ratios can be achieved without dieseling, thereby further improving the power and efficiency of the engine. Unlike a supercharger or a turbocharger, the cryogenic air cooler does not place any drag on the engine, thereby delivering enhanced power with optimal fuel efficiency. The cryogenic air condenser does not require any change of the engine configuration, and can therefore be added to a vehicle after manufacture.

The invention is a cryogenic air condenser for improving the power and fuel efficiency of an internal combustion engine powering a motor vehicle. The cryogenic air condenser includes a cryogenic cooler that brings air into thermal contact with a cryogenic liquid so as to cool the air before it enters a combustion chamber of the engine.

In preferred embodiments, the cryogenic cooler includes an outer shell with a thermally insulated interior, a cryogenic liquid containment region within the thermally insulated interior, the cryogenic liquid containment region being able to contain cryogenic liquid, an air passage that enables air to pass through the insulated interior while being cooled due to thermal, but not physical, contact with cryogenic liquid contained in the cryogenic liquid containment region, and air passage connections that are able to introduce input air into the air passage and transfer cooled output air from the air passage to an air intake of the internal combustion engine powering the motor vehicle.

In some of these embodiments, the cryogenic liquid containment region is the thermally insulated interior of the outer shell, exclusive of volume occupied by the air passage, while in other of these embodiments the air passage is the thermally insulated interior of the outer shell, exclusive of volume occupied by the cryogenic liquid containment region. Still other of these embodiments include a tube passing through the thermally insulated interior, the tube being configured so as to allow either air to pass through the tube while the tube is surrounded by a cryogenic liquid or a cryogenic liquid to be contained within the tube while air passes through a region surrounding the tube.

Yet other of these embodiments further include a thermal exchange enhancing structure in thermal contact with the cryogenic liquid containment region and extending into the air passage, thereby providing an increased area of thermal contact between air passing through the air passage and cryogenic liquid contained within the cryogenic liquid containment region. And in some of these embodiments the thermal exchange enhancing structure includes metal fins, a wire mesh, wire wool, linked metal chains, twisted metal, and/or other high surface area, high thermal conductivity structures.

In preferred embodiments, the cryogenic air condenser further includes a cryogen reservoir connected to the cryogen cooler and able to replenish cryogenic liquid within the cryogenic cooler as cryogenic liquid evaporates from the cryogenic cooler. Some of these embodiments further include a ball-valve that is able to control a flow of cryogenic liquid from the cryogen reservoir into the cryogenic cooler.

Certain preferred embodiments further include a cryogen boil-off vent configured so as to release evaporated cryogenic liquid from the cryogenic cooler. And some of these embodiments further include a Venturi tube configured so as to direct the evaporated cryogenic liquid from the boil-off vent into an exhaust flow of the internal combustion engine, thereby causing a Venturi pressure reduction and a consequent temperature reduction of cryogenic liquid contained within the cryogenic cooler. Some of these embodiments further include a ball valve that controls a flow of the evaporated cryogenic liquid from the boil-off vent into the exhaust flow of the internal combustion engine. In other of these embodiments the Venturi tube is composed at least partly of flexible, stainless steel vent line. And in yet other of these embodiments the Venturi tube does not cause the evaporated cryogenic liquid to flow through a catalytic converter of the motor vehicle.

In various preferred embodiments, the cryogenic cooler is able to contain a cryogenic liquid that is liquid nitrogen, liquid helium, or liquid air. In certain preferred embodiments the cryogenic cooler is manufactured at least in part from one of stainless steel, monel and titanium. In other preferred embodiments the cryogenic cooler includes a pressure relief valve that automatically vents evaporated cryogenic liquid into an ambient surrounding region when the evaporated cryogenic liquid exceeds a specified maximum pressure. And in other preferred embodiments the cryogenic cooler includes at least one of PVC type and Firnco type fittings.

In preferred embodiments, air cooled by the cryogenic cooler flows through an air passage of the cryogenic cooler with a total cross-sectional area that is nowhere less than an inner cross-sectional area of an intake manifold of the internal combustion engine. Other preferred embodiments further include at least one drain valve that enables water condensed in the air passage to drain from the cryogenic air condenser.

### BRIEF DESCRIPTION OF THE DRAWINGS

The invention will be more fully understood by reference to the detailed description, in conjunction with the following figures, wherein:

FIG. 1A is a cross-sectional side view of a cryogenic air condenser assembly for providing cooled air according to an embodiment of the present invention in which air flows through tubes surrounded by cryogenic liquid;

FIG. 1B is a cross-sectional side view of a cryogenic air condenser assembly similar to FIG. 1A but including a cryogen reservoir that is able to replenish cryogenic liquid in the cryogenic cooler;

FIG. 2A is a cross-sectional side view of tubes used in the cryogenic air condenser of FIG. 1A;

FIG. 2B is an end view of a flange used in the cryogenic air condenser of FIG. 1A; and

FIG. 3 is a cross-sectional side view of a cryogenic air condenser according to an alternate embodiment of the present invention in which air flows through a space surrounding tubes filled with cryogenic liquid.

### DETAILED DESCRIPTION OF PREFERRED EMBODIMENTS

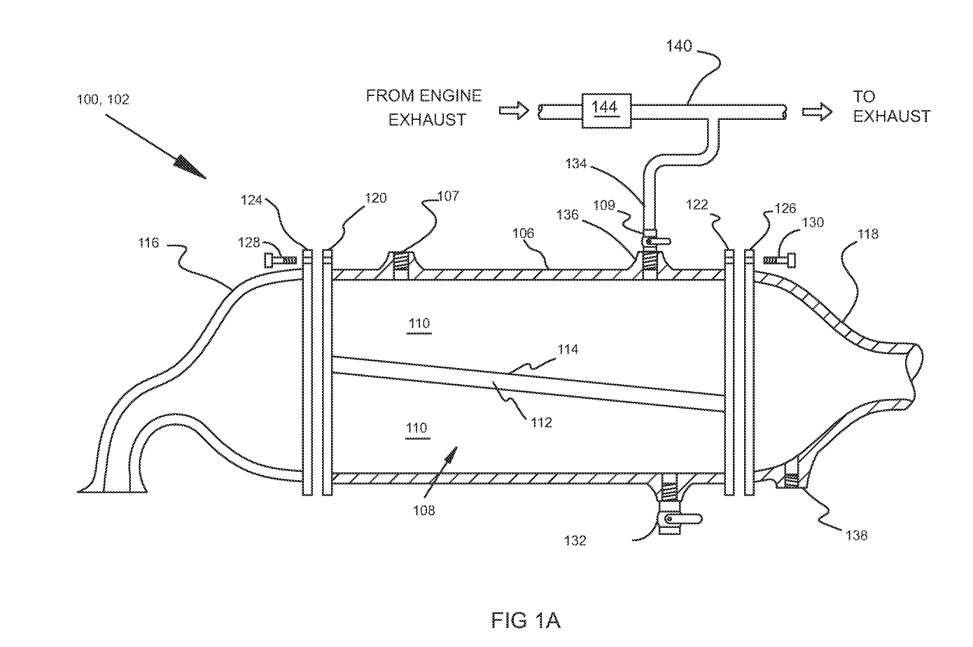

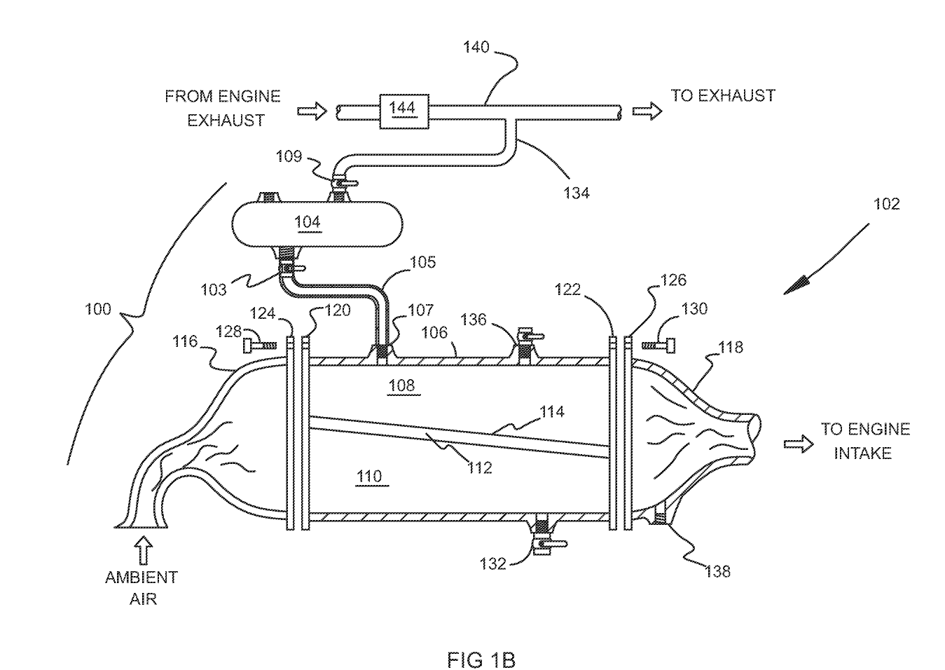

With reference to FIG. 1A, a cryogenic air condenser 100 for providing cooled air to an internal combustion engine is disclosed. The cryogenic air condenser 100 includes a cryogenic cooler 102 that is configured to cool ambient air before the air enters a combustion chamber of the internal combustion engine (not shown in the figure). In various embodiments, the cryogenic cooler 102 is configured to contain liquid nitrogen, liquid helium, liquid air, or any other generally known cryogenic liquid.

In the preferred embodiment of FIG. 1A, the cryogenic cooler 102 includes an outer shell 106 which has a thermally insulated interior 108. The thermal insulation can be physically located either inside or outside of the outer shell 106, but serves in either case to thermally isolate the interior 108. The volume defined by the thermally insulated interior 108 includes a cryogenic liquid containment region 110 and an air passage 112. The cryogenic liquid containment region 110 is configured to contain a cryogenic liquid, while the air passage is configured to enable air to pass through the thermally insulated region 108 so as to come into thermal but not physical contact with the cryogenic liquid. In the embodiment of FIG. 1A, the cryogenic liquid containment region 110 is the insulated interior 108 of the outer shell 106 exclusive of volume occupied by the air passage 112.

The cryogenic liquid containment region 110 and the air passage 112 are physically separated by a dividing structure 114 which is configured to provide a thermal interface between the cryogenic liquid in the cryogenic liquid containment region 110 and the air in the air passage 112, while keeping the air and the cryogenic liquid physically separated. In the embodiment of FIG. 1A, the dividing structure is a metal tube 114. The metal tube 114 passes through the outer shell 106 and the thermally insulated interior 108. Both ends of the tube 114 are sealed to the outer shell 106 so as to allow air to pass through the tube 114 while preventing air from entering the region surrounding the tube.

For the sake of simplicity, only one tube 114 is illustrated in FIG. 1A. However, those skilled in the art will appreciate that there can be a plurality of such tubes configured in parallel as a manifold so as to increase the total cross-sectional area of the air passage while providing a large area of thermal contact between the air passage and the cryogenic liquid containment region 110. It will be further appreciated that in preferred embodiments the dividing structure 114 can have a shape other than that of a tube, such as a square or a star, and that such shapes will occur readily to those skilled in the art as being within the scope and spirit of the present invention.

According to some embodiments, at least one of the outer shell 106 and the dividing structure 114 is composed, at least partially, of stainless steel, monel titanium or any combination of the above.

Air passage connections 116, 118 are configured so as to introduce ambient air into the cryogenic cooler 102 and so as to transfer cooled air from the cryogenic cooler 102 to the engine. More specifically, an air inlet connection 116 introduces ambient air into the air passage 112, and an air outlet connection 118 transfers cooled air from the air passage 112 to an air intake of the internal combustion engine (not shown in the figure). According to some embodiments, the air passage connections 116, 118 include at least one of a PVC type pipe and/or Firnco type fittings. And in various embodiments, the cryogenic cooler 102 and/or the outlet connection 118 are thermally insulated using a foam material such as Styrofoam, an evacuated space, a reflective material such as silvered Mylar (to reflect infra-red radiation), and/or other thermally insulating materials known in the art.

In the embodiment of FIG. 1A, the outer shell 106 has a generally cylindrical shape, with flanges 120, 122 welded to either end of the outer shell 106. Flange bolts 128 and 130 are used to bolt the outer shell flanges 120, 122 to compatible air passage connection flanges 124, 126 welded to the air passage connections 116, 118. In other embodiment, the outer shell flanges 120,122 and air passage connection flanges 124, 126 are attached to each other using other suitable attachment mechanisms generally known in the art. Furthermore, it is appreciated that other attachment means can be similarly deployed for attaching the flanges 120, 122, 124, 126 to the outer shell 106 and to the air passage connections 116, 118 without deviating from the scope of the present invention.

As discussed above, the cryogenic liquid contained in the cryogenic cooler 102 absorbs heat from the air through the thermal interface provided by the dividing structure 114. This absorption of heat, as well as unavoidable heat leaks from the ambient surroundings, will cause the cryogenic liquid to boil. In the embodiment of FIG. 1A, a cryogenic liquid boil-off vent 136 is provided so as to allow evaporated cryogenic liquid to escape from the cryogenic liquid containment region 110. In preferred embodiments, the boil-off vent 136 is configured so as to release evaporated cryogenic liquid when a predetermined pressure level is reached, the predetermined pressure level being determined according to a degree of pressure that can be safely contained within the cryogenic cooler according to the preferred embodiment. In some embodiments, the predetermined pressure level is 32 psi.

The cooler 102 further includes at least one drain valve 138 in the air passage outlet connection 118 to enable drainage of water condensed in the air passage 112. In the embodiment of FIG. 1A, the air passage 112 is sloped so as to cause condensed water to run out of the air passage 112 and into the outlet connection 118. The cooler 102 also includes a cryogenic liquid inlet 132 for allowing an inflow of cryogenic liquid.

The cryogenic air condenser 100 further includes a Venturi tube 134 connected to the boil-off vent 136. The Venturi tube 134 is configured to direct the evaporated cryogenic liquid from the boil-off vent 136 into the exhaust flow 140 of the engine. The connection of the Venturi tube 134 to the exhaust flow 140 causes a Venturi pressure reduction within the cryogenic liquid containment region 110, and a corresponding reduction in the temperature of the cryogenic liquid. According to some embodiments, the Venturi tube 134 is made from a flexible, stainless steel vent line, and in some embodiments it is attached to the exhaust flow at a point downstream of the catalytic converter 144.

FIG. 1B illustrates an embodiment of the cryogenic air condenser 100 similar to the embodiment of FIG. 1A, except that the cryogenic cooler 102 is coupled to a cryogenic liquid reservoir 104 that can be filled with additional cryogenic liquid, so as to replenish the cryogenic liquid in the cryogenic cooler as cryogenic liquid evaporates. The cryogenic cooler 102 is connected to the cryogenic liquid reservoir 104 through a connecting member 105 configured to communicate a cryogenic liquid from the cryogenic liquid reservoir 104 to the cryogenic cooler 102. In preferred embodiments, the connecting member includes a braided flexible stainless steel metallic line 105 that connects to the cryogenic liquid inlet 107 of the cryogenic cooler 102. In some embodiments, a ball-valve 103 is configured to regulate the flow of the cryogenic liquid from the cryogenic liquid reservoir 104 to the cryogenic liquid containment region 110.

A second ball valve 109 controls the flow of the evaporated cryogenic liquid into the exhaust flow 140. As in FIG. 1A, if the exhaust flow 140 includes a catalytic converter 144, the Venturi tube 134 is connected to the exhaust flow such that evaporated cryogenic liquid from the Venturi tube 134 does not flow through the catalytic converter 144. This may be achieved, for example, as illustrated in FIG. 1A and FIG. 1B, by positioning the Venturi tube 134 downstream of the catalytic converter 144. According to some embodiments, a portion of the Venturi tube 134 is positioned proximal to a fuel line of the motor vehicle.

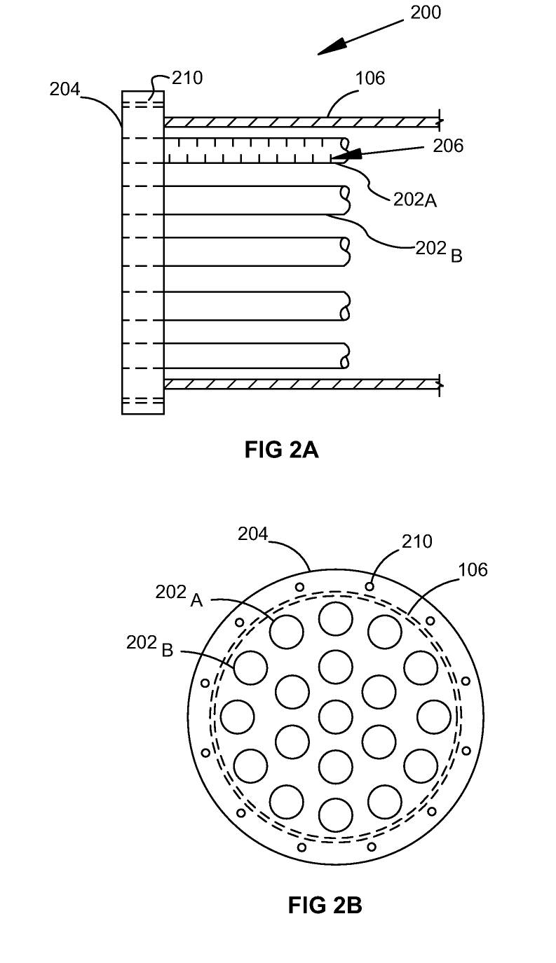

FIG. 2A illustrates a partial side portion 200 of the outer shell 106 of FIG. 1A and FIG. 1B, according to a preferred embodiment of the present invention. FIG. 2A is a partial side view of the outer shell 106 in which a plurality of tubes 202_{A}, 202_{B}, . . . , 202_{N} (hereinafter referred to by “202”) are illustrated as being sealed to the outer shell 106 such that air can flow through the tubes 202 and thereby through the outer shell 106 and the thermally insulated interior 108, without the air leaking into the space surrounding the tubes 202. In the embodiment of FIG. 2A, the tubes 202 are welded to the flanges 120,122 that form the ends of the outer shell 106. The plurality of tubes 202 collectively serve as the air passage 112 through the insulated interior 108. According to some embodiments, the collective cross-sectional area of the air passage 112 is nowhere less than the inner cross-sectional area of the intake manifold of the internal combustion engine. This ensures that if and when the cryogenic cooler is not filled with a cryogenic liquid and is therefore not in operation, the cryogenic cooler will not constrict the flow of air into the intake manifold, and the engine will perform in a normal manner as if the cryogenic cooler were not installed.

In the preferred embodiment of FIG. 2A, a thermal exchange enhancing structure 206 is included inside of the tubes 202 so as to increase the thermal contact between air passing through the tubes 202 and the cryogenic liquid in the surrounding cryogenic liquid containment region 110. In the embodiment of FIG. 2A the thermal exchange enhancing structure 206 is a plurality of metal fins extending from the inner walls of the tubes. In other preferred embodiments, the thermal exchange enhancing structure 206 includes one or more of a wire mesh, wire wool, linked metal chains, twisted metal, and other air-permeable, high surface area, high thermal conductivity structures, such as those generally known in the art. For simplicity of illustration, only tube 202_{A} is shown with the fins 206, while typically all of the tubes 112 are configured in an identical manner. Those skilled in the art will appreciate that a thermal exchange enhancing structure 206 may also be included in the cryogenic liquid containment region 110 so as to improve the efficiency of thermal exchange with the cryogenic liquid. Those skilled in the art will also appreciate that the total cross-sectional area of the air passage 112 can be increased so as to compensate for drag imposed on the air by any thermal enhancing structure 206 placed within the air passage 112.

FIG. 2B illustrates an end view of the flange 204 that forms one end of the outer shell 108. The open ends of the plurality of tubes 112 can be seen in the flange 204. These openings provide for entry of air into the tubes 202. A plurality of bolt holes 210 can also be seen in the flange 204 for receiving flange bolts 128, 130 that connect the flange 204 to a compatible flange 124, 126 of an air flow connector 116. The plurality of tubes 202 is welded to the flange 204 along the periphery of the openings, thereby providing an air passage through the insulated interior 108. It is appreciated here that the shape of the openings and the cross section of the tubes 202 varies in different embodiments according to desired applications. It is further appreciated that techniques other than welding can be deployed in various embodiments for attaching the ends of the tubes 202 to the openings without departing from the scope and spirit of the present invention.

It is further appreciated here that the other ends of the tubes 202 are connected to a second flange in a similar configuration to FIG. 2B at the other end of the outer shell 106.

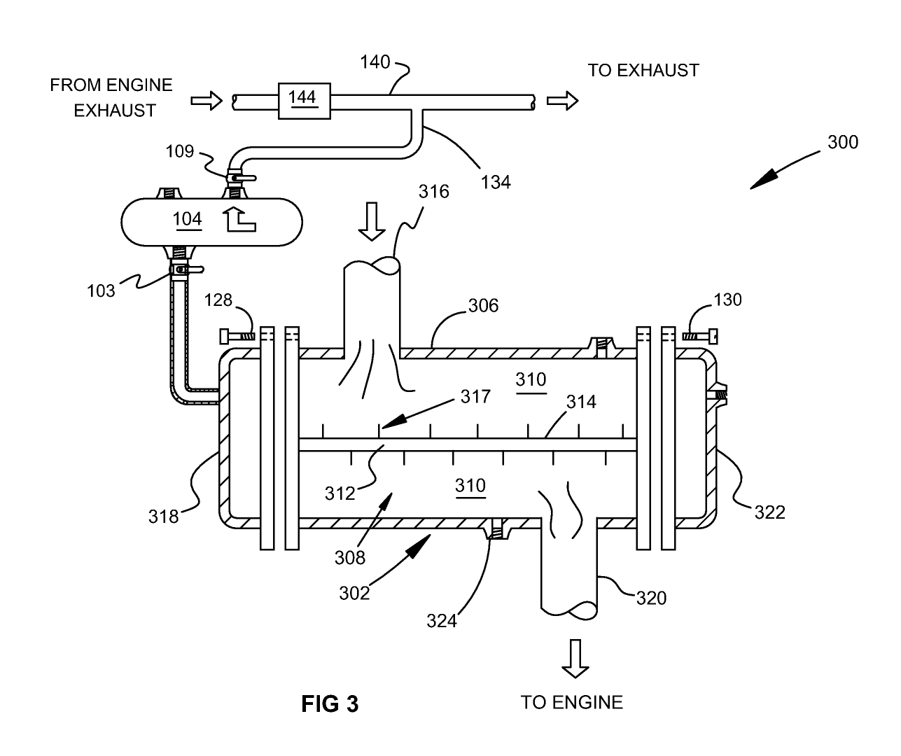

FIG. 3 illustrates a cryogenic air condenser 300 according to another preferred embodiment of the present invention. As in the embodiment of FIG. 1A, the cryogenic cooler 302 of FIG. 3 includes an outer shell 306 having a thermally insulated interior 308. However, the configuration of FIG. 3 is essentially inverted as compared to FIG. 1A, with the cryogenic liquid contained in a cryogenic liquid containment region 312 within one or more tubes 314 and the remainder of the thermally insulated interior 308 forming the air passage 310 within which air is cooled as it flows past the outer walls of the tubes 314. The volume defined by the thermally insulated interior 308 includes the air passage 310 and the cryogenic liquid containment region 312. The dividing structure 314 of the tubes is configured to provide a thermal interface between the cryogenic liquid in the tubes 314 and the air in the air passage 310. However, the dividing structure 314 does not allow a physical contact between the air and the cryogenic liquid. In operation, the ambient air enters from an air inlet 316 into the thermally insulated interior 308 of the outer shell 306. The cryogenic liquid enters the cryogenic air condenser 300 from a cryogenic liquid reservoir (not shown) through a cryogenic liquid passage inlet connection 318, and passes through the outer shell 306 while contained in the tubes 314. The air in the air passage 310 of the thermally insulated interior 308 is cooled due to the transfer of heat to the cryogenic liquid in the tubes 314, and the cooled air exits from the outer shell 306 into an air outlet 320. The cooling of air is enhanced by addition of thermal exchange enhancing structures, such as fins 317. The evaporated cryogenic liquid exits the cryogenic liquid reservoir 104 into the exhaust 140 from the engine through a cryogenic liquid passage outlet connection 134. The evaporated cryogenic liquid exits the cryogenic liquid reservoir 104 preferably downstream to the catalytic converter 144. It is appreciated that water may condense from the cooled air, and a drain valve 324 is configured to drain out the condensed water, if any, from the outer shell 306. It is appreciated here that the cryogenic air condenser 300 will have other fittings, valves, vent lines and other components oriented according to the desired flow of the cryogenic liquid and the air, and all such configurations required by the cryogenic air condenser 300 will occur readily to those skilled in the art. Accordingly, such and other obvious variant configurations of air condensers illustrated herein are included within the scope and spirit of the present invention.

Those skilled in the art will appreciate that the cryogenic air condenser 102 of FIG. 1A and 1B and the cryogenic air condenser 300 of FIG. 3, are shown in partially assembled configurations, for the purpose of simplicity of illustration. For example, the air passage connections (FIG. 1A, 1B) or the cryogenic liquid passage connections (FIG. 3) are unified with the cryogenic air condenser 100 or the cryogenic air condenser 300, respectively.

Various embodiments of the present invention offer various advantages. For example, by lowering the temperature (and hence increasing the density) of the air drawn into the engine, more air is available within the combustion chambers for combustion, and when combined with a suitably increased amount of fuel, more power is delivered. Further, due to the cooled air, the engine cylinders (and the combustion chamber) are cooled, which allows higher compression ratios without dieseling, thereby providing higher combustion efficiency. Furthermore, the lower air temperature causes combustion to take place at a slower rate, delivering power over a longer time period during the combustion process and thereby further increasing the efficiency of the engine, in much the same way as if the “octane” rating of the fuel had been increased. Accordingly, various techniques described herein provide for increasing the power output of internal combustion engines while enhancing the fuel efficiency.

Other modifications and implementations will occur to those skilled in the art without departing from the spirit and the scope of the invention as claimed. Accordingly, the above description is not intended to limit the invention except as indicated in the following claims.

What is claimed is:

1. A cryogenic air condenser for improving power and fuel efficiency of an internal combustion engine powering a motor vehicle, the cryogenic air condenser comprising a cryogenic cooler that brings air into thermal contact with a cryogenic liquid so as to cool the air before it enters a combustion chamber of the engine.

2. The cryogenic air condenser of claim 1, wherein the cryogenic cooler includes:
an outer shell with a thermally insulated interior;
a cryogenic liquid containment region within the thermally insulated interior, the cryogenic liquid containment region being able to contain cryogenic liquid;
an air passage that enables air to pass through the insulated interior while being cooled due to thermal, but not physical, contact with cryogenic liquid contained in the cryogenic liquid containment region; and
air passage connections that are able to introduce input air into the air passage and transfer cooled output air from the air passage to an air intake of the internal combustion engine powering the motor vehicle.

3. The cryogenic air condenser of claim 2, wherein the cryogenic liquid containment region is the thermally insulated interior of the outer shell, exclusive of volume occupied by the air passage.

4. The cryogenic air condenser of claim 2, wherein the air passage is the thermally insulated interior of the outer shell, exclusive of volume occupied by the cryogenic liquid containment region.

5. The cryogenic air condenser of claim 2, further comprising a tube passing through the thermally insulated interior, the tube being configured so as to allow one of:
air to pass through the tube while the tube is surrounded by a cryogenic liquid; and
a cryogenic liquid to be contained within the tube while air passes through a region surrounding the tube.

6. The cryogenic air condenser of claim 2 further comprising a thermal exchange enhancing structure in thermal contact with the cryogenic liquid containment region and extending into the air passage, thereby providing an increased area of thermal contact between air passing through the air passage and cryogenic liquid contained within the cryogenic liquid containment region.

7. The cryogenic air condenser of claim 6, wherein the thermal exchange enhancing structure includes at least one of:
metal fins;
a wire mesh;
wire wool;
linked metal chains;
twisted metal; and
other high surface area, high thermal conductivity structures.

8. The cryogenic air condenser of claim 1, further comprising a cryogenic liquid reservoir connected to the cryogenic cooler and able to replenish cryogenic liquid within the cryogenic cooler as cryogenic liquid evaporates from the cryogenic cooler.

9. The cryogenic air condenser of claim 8, further comprising a ball-valve that is able to control a flow of cryogenic liquid from the cryogenic liquid reservoir into the cryogenic cooler.

10. The cryogenic air condenser of claim 1, further comprising a cryogenic liquid boil-off vent configured so as to release evaporated cryogenic liquid from the cryogenic cooler.

11. The cryogenic air condenser of claim 10, further comprising a Venturi tube configured so as to direct the evaporated cryogenic liquid from the boil-off vent into an exhaust flow of the internal combustion engine, thereby causing a Venturi pressure reduction and a consequent temperature reduction of cryogenic liquid contained within the cryogenic cooler.

12. The cryogenic air condenser of claim 11, further comprising a ball valve that controls a flow of the evaporated cryogenic liquid from the boil-off vent into the exhaust flow of the internal combustion engine.

13. The cryogenic air condenser of claim 11, wherein the Venturi tube is composed at least partly of flexible, stainless steel vent line.

14. The cryogenic air condenser of claim 11, wherein the Venturi tube does not cause the evaporated cryogenic liquid to flow through a catalytic converter of the motor vehicle.

15. The cryogenic air condenser of claim 1, wherein the cryogenic cooler is able to contain a cryogenic liquid that is one of:
liquid nitrogen;
liquid helium; and
liquid air.

16. The cryogenic air condenser of claim 1, wherein the cryogenic cooler is manufactured at least in part from one of stainless steel, monel and titanium.

17. The cryogenic air condenser of claim 1, wherein the cryogenic cooler includes a pressure relief valve that automatically vents evaporated cryogenic liquid into an ambient surrounding region when the evaporated cryogenic liquid exceeds a specified maximum pressure.

18. The cryogenic air condenser of claim 1, wherein the cryogenic cooler includes at least one of PVC type pipe and Firnco type fittings.

19. The cryogenic air condenser of claim 1, wherein air cooled by the cryogenic cooler flows through an air passage of the cryogenic cooler with a total cross-sectional area that is nowhere less than an inner cross-sectional area of an intake manifold of the internal combustion engine.

20. The cryogenic air condenser of claim 1, further comprising at least one drain valve that enables water condensed in the air passage to drain from the cryogenic air condenser.
